(19) United States
(12) Patent Application Publication
(10) Pub. No.: US 2006/0196229 A1
(43) Pub. Date: Sep. 7, 2006

(54) METHOD FOR FABRICATING INJECTION MOLD CORE

(76) Inventor: Wen-Ssu Chiu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,206

(22) Filed: Dec. 20, 2005

(30) Foreign Application Priority Data
Jan. 26, 2005 (CN) 200510033019.7

(51) Int. Cl. C03B 11/00; C03B 11/08

(52) U.S. Cl. 65/66; 65/374.13

(57) ABSTRACT

The present invention relates to a method for fabricating an injection mold core for a plastic optical article. The method includes the steps of: (a) providing a pressing member with a pressing surface having a predetermined shape; (b) providing a substrate with an injection mold core preform being placed thereon; (c) pressing the pressing member onto the injection mold core preform thereby forming an injection mold core with a surface having a reversed shape of the pressing surface; (d) separating the pressing member from the injection mold core.

### FIELD OF THE INVENTION

The present invention relates to injection molds, and more particularly to a method for fabricating an injection mold core suitable for forming an optical article.

### DESCRIPTION OF RELATED ART

Injection molding has been widely used for manufacturing optical articles, such as a light guide plate, a lens, and the like. Generally, a typical injection molding method includes the steps of injecting a raw material into a mold, and molding the raw material into a desired product having a given shape.

Generally, an injection mold includes a male mold core and a female mold core. The male or the female mold core may include a molding surface having a given shape. The shape of the molding surface may be substantially concave or convex. The shape of the molding surface may further include a plurality of protrusions or grooves. The shape of the molding surface is configured to be the reversed shape of the desired product.

Conventionally, the mold core is generally fabricated by ultra-precision machining technique. A typical ultra-precision machining process for making a mold core includes a plurality of necessary machining steps such as milling, grinding, polishing, and so on. Therefore, such process is time-consuming and has high manufacturing cost. In addition, in order to mass-produce optical articles, a great number of mold core has to be manufactured first. However, although all the mold cores are fabricated by same ultra-precision machining process, the uniformity of the mold cores is unsatisfactory. As a result, the uniformity of the optical articles formed with such mold cores is unsatisfactory accordingly. Therefore, the mold cores fabricated by the ultra-precision machining process are not suitable for use in mass production of the optical articles.

It is desired to provide an improved method for mass fabricating injection mold cores that overcomes the above-described problems.

### SUMMARY OF INVENTION

A method for fabricating an injection mold core is provided. The method includes the steps of: providing a pressing member with a pressing surface having a predetermined shape; providing substrate with an injection mold core preform being placed thereon; pressing the injection mold core preform using the pressing member thereby forming an injection mold core with a reversed shape of the pressing surface; separating the pressing member from the injection mold core.

### BRIEF DESCRIPTION OF DRAWINGS

Many aspects of the present method can be better understood with reference to the following drawing. The components in the drawing are not necessarily to scale, the emphasis instead being placed upon clearly illustrating the principles of the present method. Moreover, in the drawing, like reference numerals designate corresponding parts throughout the several views.

FIG. 1 is a follow chart of a method in accordance with a preferred embodiment;

FIG. 2 is a schematic, cross-sectional view of a pressing member, in accordance with a preferred embodiment;

FIG. 3 is a schematic, cross-sectional view showing the pressing member having a pressing surface;

FIG. 4 is similar to FIG. 3, but showing the pressing member being pressed onto the injection mold core preform; and

FIG. 5 is a schematic, cross-sectional view of an injection mold core formed on the substrate after removing the pressing member.

### DETAILED DESCRIPTION

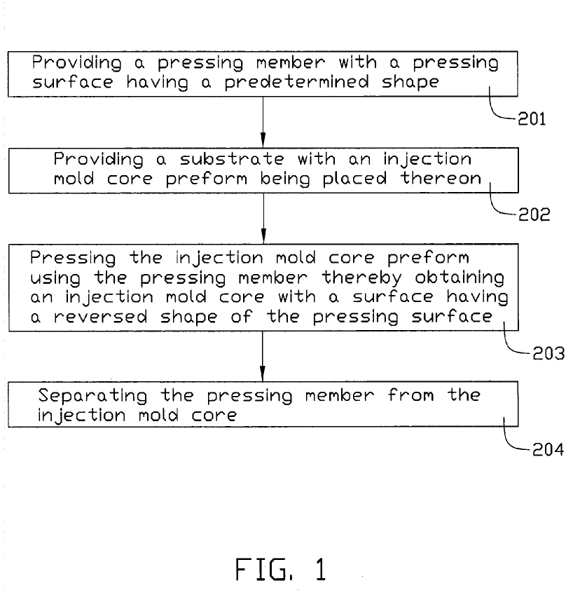

Referring to FIG. 1, a method for fabricating an injection mold core, in accordance with a preferred embodiment, includes the steps of: step 201: providing a pressing member with a pressing surface having a predetermined shape; step 202: providing a substrate with a injection mold core preform being placed thereon; step 203: pressing the injection mold core preform using the pressing member thereby obtaining an injection mold core with a surface having a reversed shape of the pressing surface; step 204: separating the pressing member from the injection mold core.

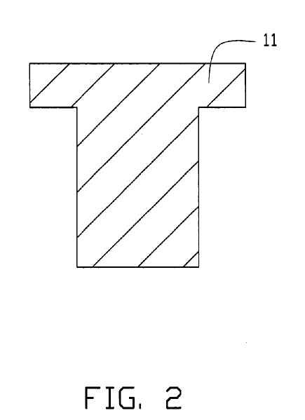

Referring to FIG. 2, a pressing member 11 is illustrated. A material of the pressing member 11 may be an ultra-hard alloy, such as tungsten carbide, silicon carbide, or the like.

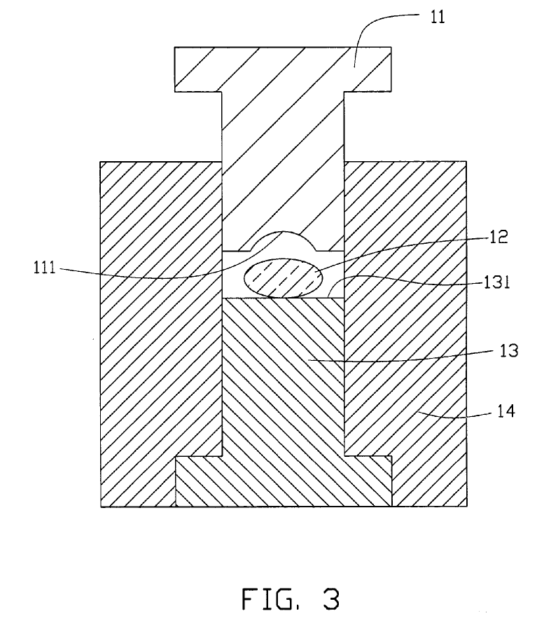

Referring to FIG. 3, the pressing member 11 is machined by conventional ultra-precision machining processes thereby forming a pressing surface 111 with a given shape. The shape of the pressing surface 111 is configured to be the reversed shape of a desired injection mold core. Generally, the shape of the injection mold core is configured to be the reversed shape of the desired optical article. So the shape of the pressing surface 111 of the pressing member 11 should be configured to be consistent with that of the desired optical article.

Providing an injection mold core preform 12 and a substrate 13. A material of the preform 12 may be glass, quartz, or a metallic material having a low melting point. A material of the substrate 13 may be a refractory material, such as stainless steel. The substrate 13 is disposed in a bushing 14 with the injection mold core preform 12 being placed on the substrate 13. The pressing member 11 is then inserted into the bushing 14.

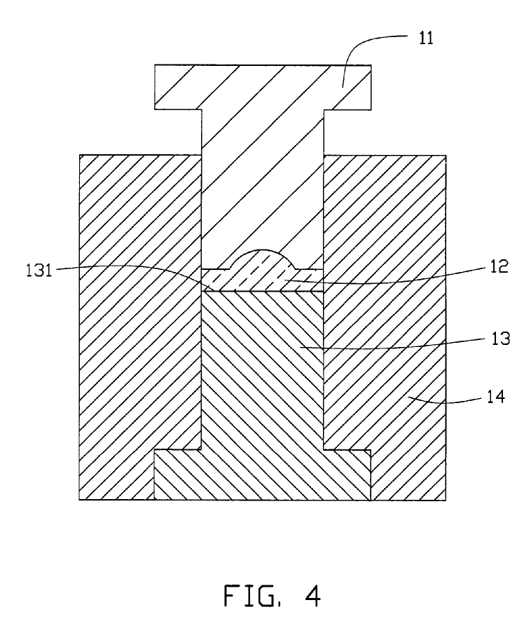

Referring to FIG. 4, a pressure is applied onto the pressing member 11, which is, in turn thereby, pressed onto the injection mold core preform 12 at a high temperature such that a surface having a reversed shape of the pressing surface 111 is formed on the injection mold core preform 12. As a result, the injection mold core preform 12 and the substrate 13 are integrated to each other. The temperature and the pressure are configured according to the material and size of the injection mold core preform 12. Generally, the temperature is configured to be in the range from about 500° C. to about 700° C. The pressure is configured to be about 1000N. Preferably, a surface of the substrate 13 is treated into a rough surface 131 for facilitating integrating the substrate 13 with the injection mold core preform 12.

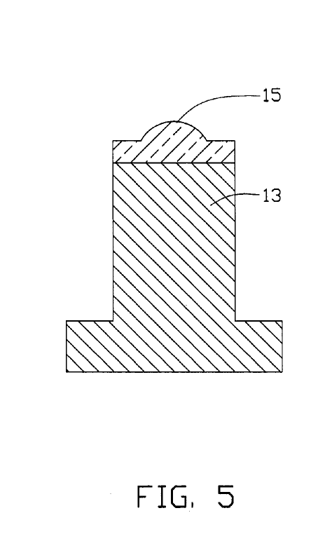

Referring to FIG. 5, the pressing member 11 is preferably pressed onto the injection mold core preform 12 for an appropriate time period. The pressing member 11 and the injection mold core preform 12 are then cooled down to room temperature. Then the pressing member 11 is separated from the injection mold core preform 12 thereby obtaining an injection mold core 15 formed on the substrate 13. The injection mold core 15 is integrated with the substrate 13.

The pressing member 11 and the injection mold core 15 may be separated by various means. For example, the injection mold core 15 could be held at rest while moving the pressing member 11 away from the injection mold core 15. Alternatively, the pressing member 11 could be held at rest while moving the injection mold core 15 away from the pressing member 11. Furthermore, the pressing member 11 and the injection mold core 15 could be separated by simultaneously moving them in opposite directions.

The present method for making injection mold cores only requires to make one pressing member 11 with a pressing surface 111 employing ultra-precision machining techniques. Then injection mold cores 15 may be mass-produced employing the pressing member 11. Therefore, the obtained injection mold cores 15 are more precise and uniform, compared to the infection mold cores obtained by the conventional necessary machining steps.

In order to form an optical article, a male mold core and a female mold core are generally needed. The male and female mold cores 15 can be made by the same method.

By performing the present method, the injection mold cores 15 can be mass-produced. In addition, most of conventional necessary ultra-precision machining steps are obviated. Thus the manufacturing cost is reduced greatly.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for fabricating an injection mold core comprising the steps of: providing a pressing member with a pressing surface having a predetermined shaped; providing a substrate with an injection mold core preform being placed thereon; pressing the injection mold core preform using the pressing member thereby obtaining an injection mold core with a surface having a reversed shape of the pressing surface; separating the pressing member from the injection mold core.

2. The method as described in claim 1, wherein the pressing member is comprised of an ultra-hard alloy.

3. The method as described in claim 2, wherein the ultra-hard alloy is selected from the group consisting of tungsten carbide and silicon carbide.

4. The method as described in claim 1, wherein the injection mold core preform is comprised of one of glass and quartz.

5. The method as described in claim 1, wherein the injection mold core preform is pressed under a pressure about 1000N.

6. The method as described in claim 1, wherein the injection mold core preform is pressed at a temperature in the range from about 500° C. to about 700° C.

7. The method as described in claim 1, wherein the injection mold core preform is pressed onto the substrate such that the injection mold core and the substrate are integrated to each other.

8. The method as described in claim 1, wherein the pressing member is separated from the injection mold core by holding the injection mold core at rest while moving the pressing member away from the injection mold core.

9. The method as described in claim 1, wherein the pressing member is separated from the injection mold core by holding the pressing member at rest while moving the injection mold core away from the pressing member.
